(19) United States
(12) Patent Application Publication
(10) Pub. No.: US 2019/0130908 A1
(43) Pub. Date: May 2, 2019

(54) SPEECH RECOGNITION DEVICE AND METHOD FOR VEHICLE

(71) Applicants: Hyundai Motor Company, Seoul (KR); Kia Motors Corporation, Seoul (KR)

(72) Inventor: Kyu Seop BANG, Suwon-si (KR)

(73) Assignees: Hyundai Motor Company, Seoul (KR); Kia Motors Corporation, Seoul (KR)

(21) Appl. No.: 16/018,934

(22) Filed: Jun. 26, 2018

(30) Foreign Application Priority Data
Nov. 2, 2017 (KR) 10-2017-0145545

(51) Int. Cl. G10L 15/22; G10L 15/08; G10L 15/30

(52) U.S. Cl. CPC G10L 15/22; G10L 15/08; G10L 2015/223; G10L 2015/088; G10L 15/30

(57) ABSTRACT

A speech recognition device for a vehicle may include: an input device receiving a command; a storage device storing a first wake-up command generated to perform terminal speech recognition with respect to the received command, and a second wake-up command generated to perform server speech recognition with respect to the received command; a control device determining whether at least one of the first wake-up command and the second wake-up command is detected from the received command, performing the terminal speech recognition if the first wake-up command is detected from the received command, and performing the server speech recognition if the second wake-up command is detected from the received command; and an output device outputting at least one of a result of the terminal speech recognition and a result of the server speech recognition.

### CROSS-REFERENCE TO RELATED APPLICATION

The present application claims priority to Korean Patent Application No. 10-2017-0145545, filed on Nov. 2, 2017, the entire contents of which is incorporated herein for all purposes by this reference.

### BACKGROUND OF THE INVENTION

### Field of the Invention

The present invention relates to a speech recognition device and method for a vehicle and, more particularly, to a speech recognition device and method for a vehicle configured for setting a wake-up command for each mode and facilitating speech recognition in a corresponding mode with respect to the input of the wake-up command.

### Description of Related art

In general, vehicles are provided with a variety of advanced electronic control systems and comfort systems in accordance with the development of electronic technologies and consumers' demand for convenience, and the operations of these electronic control systems and comfort systems may be performed on the basis of speech recognition technologies.

Speech recognition enables a computer to analyze a user's voice input through a microphone, extract features, recognize a result similar to previously input words or sentences as a command, and perform an action corresponding to the recognized command.

Existing speech recognition systems include a terminal speech recognition system in which a speech recognition engine is stored in a terminal including a vehicle terminal and a mobile terminal, and a cloud-based server speech recognition system for Internet voice search on smartphones and various information processing, and they are being used discriminatively to suit respective service purposes. Furthermore, hybrid speech recognition that can take advantage of a high recognition rate in grammar-based recognition by the terminal speech recognition system along with sentence-based recognition by the server speech recognition system is being used in the market.

The hybrid speech recognition system may receive two or more results by simultaneously driving a terminal speech recognition engine and a server speech recognition engine with respect to a user's utterance, and use a better result among the received two or more results as a command. More specifically, a speech recognition method according to the related art will be described below.

First of all, a command input by a user may be received. Here, the input wake-up command may be intended to activate a speech recognition application, and for example, “Hi, Hyundai” may be input. Next, it may be determined whether the wake-up command “Hi, Hyundai” has been received. If the wake-up command “Hi, Hyundai” has been received, the speech recognition application may be activated. If the speech recognition application is activated, a guidance prompt may be provided through a speaker. For example, “Say command” may be output. As such, a speech signal with respect to a command uttered by the user may be received. If a command “FM 91.9” is input, the speech recognition application may receive the speech signal with respect to the command, and perform the task of speech recognition by simultaneously driving the terminal speech recognition engine and the server speech recognition engine. Thereafter, the speech recognition application may receive a result of terminal speech recognition and a result of server speech recognition from the terminal speech recognition engine and the server speech recognition engine. The speech recognition application may output a better result among the plurality of results. For example, “Switch to radio” may be output.

Here, there is a limit that the terminal speech recognition engine and the server speech recognition engine should be simultaneously driven to search for the command, because it is difficult to immediately determine whether the command input by the user corresponds to a command for terminal speech recognition and a command for server speech recognition.

Therefore, even if the command uttered by the user corresponds to the terminal speech recognition command, it may be searched with the server speech recognition engine driven unnecessarily, causing the problem of unnecessary data consumption. Furthermore, even if the command uttered by the user corresponds to the server speech recognition command, it may be searched with the terminal speech recognition engine driven unnecessarily, which may cause an overload of the terminal.

The information disclosed in this Background of the. Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a speech recognition device and method for a vehicle, configured for improving speech recognition rate by generating a new command to include a wake-up command classified and registered according to a service domain, detecting the wake-up command included in the new command if the new command is input, and determining the corresponding service domain to which the new command belongs.

According to various aspects of the present invention, a speech recognition device configured for a vehicle may include: an input device receiving a command; a storage device storing a first wake-up command generated to perform terminal speech recognition with respect to the received command, and a second wake-up command generated to perform server speech recognition with respect to the received command; a control device determining whether at least one of the first wake-up command and the second wake-up command is detected from the received command, performing the terminal speech recognition if the first wake-up command is detected from the received command, and performing the server speech recognition if the second wake-up command is detected from the received command; and an output device outputting at least one of a result of the terminal speech recognition and a result of the server speech recognition.

The input device may receive the command including at least one of the first wake-up command and the second wake-up command.

The storage device may store the first wake-up command generated based on at least one of a predetermined word and a predetermined phrase of a command for acquiring a result which is derived by performing a search based on information stored in a vehicle terminal and a user's personal device connected to the vehicle terminal.

The storage device may store the second wake-up command generated based on at least one of a predetermined word and a predetermined phrase of a command for acquiring a result which is derived by performing a search based on information related to a web server.

The control device may recognize the received command by distinguishing between the wake-up command and an action command on the basis of the first wake-up command and the second wake-up command stored in the storage device, and detect the wake-up command as at least one of the first wake-up command and the second wake-up command.

The control device may perform the terminal speech recognition through an action of searching for a result corresponding to the user's command on the basis of information stored in a vehicle terminal and a personal device connected to the vehicle terminal.

The control device may perform the server speech recognition through an action of searching for a result corresponding to the user's command on the basis of information related to a web server.

The control device may perform the terminal speech recognition by allowing the speech recognition of the received command to be performed in a service domain based on a vehicle terminal and a personal device connected to the vehicle terminal.

The control device may perform the server speech recognition by allowing the speech recognition of the received command to be performed in a service domain based on a web server.

According to various aspects of the present invention, a speech recognition method for a vehicle may include: receiving a command; detecting at least one of a first wake-up command and a second wake-up command from the received command; performing terminal speech recognition if the first wake-up command is detected from the received command, and performing server speech recognition if the second wake-up command is detected from the received command; and outputting at least one of a result of the terminal speech recognition and a result of the server speech recognition.

The speech recognition method may further include storing the first wake-up command generated based on at least one of a predetermined word and a predetermined phrase of a command for acquiring a result which is derived by performing a search based on information stored in a vehicle terminal and a user's personal device connected to the vehicle terminal, before the receiving of the command.

The speech recognition method may further include storing the second wake-up command generated based on at least one of a predetermined word and a predetermined phrase of a command for acquiring a result which is derived by performing a search based on information related to a web server, before the receiving of the command.

The receiving of the command may include receiving the command including at least one of the first wake-up command and the second wake-up command.

The detecting of at least one of a first wake-up command and a second wake-up command from the received command may include: recognizing the received command by distinguishing between the wake-up command and an action command on the basis of the stored first wake-up command and the stored second wake-up command; and detecting the wake-up command as at least one of the first wake-up command and the second wake-up command.

The performing of the terminal speech recognition if the first wake-up command is detected from the received command, and the performing of the server speech recognition if the second wake-up command is detected from the received command may include: performing the terminal speech recognition through an action of searching for a result corresponding to the user's command on the basis of information stored in a vehicle terminal and a personal device connected to the vehicle terminal; and performing the server speech recognition through an action of searching for a result corresponding to the user's command on the basis of information related to a web server.

The performing of the terminal speech recognition if the first wake-up command is detected from the received command may include performing the terminal speech recognition by allowing the speech recognition of the received command to be performed in a service domain based on a vehicle terminal and a personal device connected to the vehicle terminal.

The performing of the server speech recognition if the second wake-up command is detected from the received command may include performing the server speech recognition by allowing the speech recognition of the received command to be performed in a service domain based on a web server.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a speech recognition system for a vehicle, according to an exemplary embodiment of the present invention;

FIG. 2 illustrates the configuration of a speech recognition device configured for a vehicle, according to an exemplary embodiment of the present invention;

FIG. 3 illustrates a speech recognition method for a vehicle, according to an exemplary embodiment of the present invention;

FIG. 4 illustrates a speech recognition method for a vehicle, according to another exemplary embodiment of the present invention;

FIG. 5 illustrates a flowchart of a speech recognition method for a vehicle, according to an exemplary embodiment of the present invention; and

FIG. 6 illustrates the configuration of a computing system by which a method according to an exemplary embodiment of the present invention is executed.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Terms including first, second, A, B, (a), and (b) may be used to describe the elements in exemplary embodiments of the present invention. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present invention belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

A speech recognition system, according to exemplary embodiments of the present invention, may receive a command input by a user, activate a speech recognition application if a predetermined wake-up command is detected from the received command, activate a service domain to which the predetermined wake-up command belongs, allow the received command to be searched in the corresponding service domain, and output a result. To the present end, the command may include a predetermined wake-up command. In other words, the command may include a predetermined wake-up command and an action command.

Since the command which is input to the speech recognition system according to exemplary embodiments of the present invention may include the predetermined wake-up command, the utterance and reception of a separate wake-up command for activating the speech recognition application may be omitted. Thus, with only the received command, a result corresponding to the command may be output. In other words, a search may be made in the service domain associated with the received command, and thus the result corresponding to the command may be output rapidly and accurately.

A wake-up command, according to exemplary embodiments of the present invention, may be generated based on some predetermined words or phrases of a command that users generally input. As described above, the command may be generated to include the wake-up command so that if a speech signal corresponding to the command is received, the wake-up command may be detected from the speech signal to activate the speech recognition application.

Furthermore, the wake-up command may be generated by distinguishing whether the command input by the user corresponds to a command for terminal speech recognition or a command for server speech recognition. This is intended to search for the command in the service domain associated with the wake-up command. Here, the terminal speech recognition command refers to a command that allows a result with respect to the command to be derived from information related to a vehicle terminal and information related to a user's personal device connected to the vehicle terminal, and the server speech recognition command refers to a command that allows a result with respect to the command to be derived from information related to a web server. The vehicle terminal may include a speech recognition device configured for a vehicle according to exemplary embodiments of the present invention, but is not limited thereto.

Hereinafter, for convenience of explanation, a wake-up command included in the terminal speech recognition command is referred to as a first wake-up command, and a wake-up command included in the server speech recognition command is referred to as a second wake-up command.

The first wake-up command may be generated based on some predetermined words or phrases of a command for acquiring a result that may be derived by performing a search based on the information stored in the vehicle terminal and the user's personal device.

According to exemplary embodiments, the first wake-up command may include, for example, “FM”, “RADIO” and “AM”, which allows a search to be made in a service domain of “radio” to derive a result. Furthermore, the first wake-up command may include, for example, “Call” and “Make a call”, which allows a search to be made in a service domain of “call” to derive a result.

Furthermore, the second wake-up command may be generated based on some predetermined words or phrases of a command for acquiring a result that may be derived by performing a search based on the information related to the web server if it cannot be searched based on the information stored in the vehicle terminal and the user's personal device. In other words, the second wake-up command may include some predetermined words or phrases of a command for acquiring a result that may be derived by searching for large vocabulary.

According to exemplary embodiments, the second wake-up command may include, for example, “Find” and “Navigate to”, which allows a search to be made in a service domain of “POI (point of interest)/address search” to derive a result. Furthermore, the second wake-up command may include, for example, “Send”, which allows a search to be made in a service domain of “SMS” to derive a result.

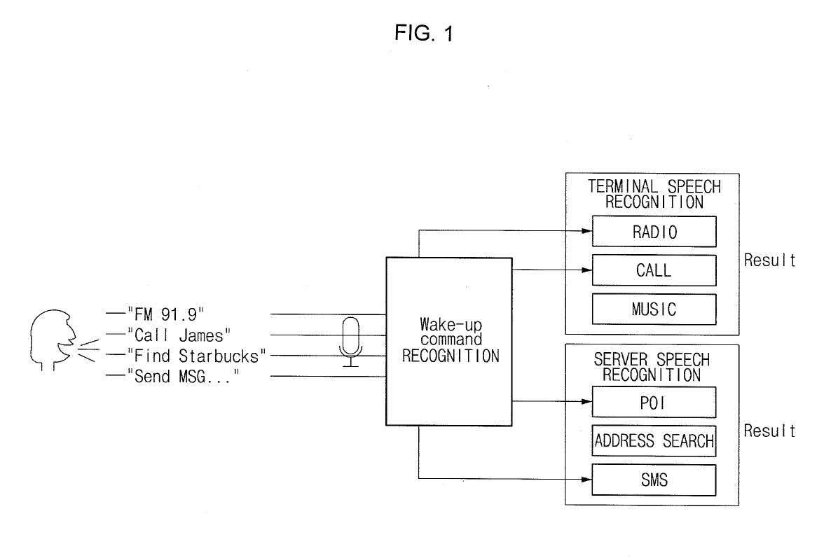

Furthermore, the first wake-up command and the second wake-up command may be registered in advance, and be detected from a speech signal corresponding to the command input by the user. A detailed description thereof will be provided with reference to FIG. 1. FIG. 1 illustrates a speech recognition system for a vehicle, according to an exemplary embodiment of the present invention.

Referring to FIG. 1, if an initial command including preregistered first and second wake-up commands including “FM 91.9”, “Call James”, “Find starbucks”, and “Send message”, is input and a speech signal with respect to the initial command is received, at least one of the first and second wake-up commands may be detected from the speech signal. According to exemplary embodiments, “FM” and “Call” may be included in the first wake-up command, and “Find” and “Send” may be included in the second wake-up command. Since any one of the first and second wake-up commands is detected in a process of receiving the speech signal with respect to the initial command, a speech recognition application may be activated. If at least one of the first and second wake-up commands is detected from the initial command, a result with respect to the initial command may be searched in a service domain associated with the detected wake-up command.

According to exemplary embodiments, there is no need to perform a series of processes for activating the speech recognition application, as in the related art, including: inputting a separate wake-up command, determining whether a speech signal with respect to the wake-up command is received, and additionally requesting the user to input a desired command if the speech signal with respect to the wake-up command is received. By allowing a result with respect to the command to be searched in a predetermined service domain, speech recognition may be performed rapidly and accurately.

As illustrated in FIG. 1, if the initial command “FM 91.9” and “Call James” is input, terminal speech recognition may be performed as the first wake-up command is detected, and thus the result corresponding to the command may be searched in the service domain of “radio” and “call”, respectively. Furthermore, if the initial command “Find starbucks” and “Send message” is input, server speech recognition may be performed as the second wake-up command is detected, and thus the result corresponding to the command may be searched in the service domain of “POI” and “SMS”, respectively.

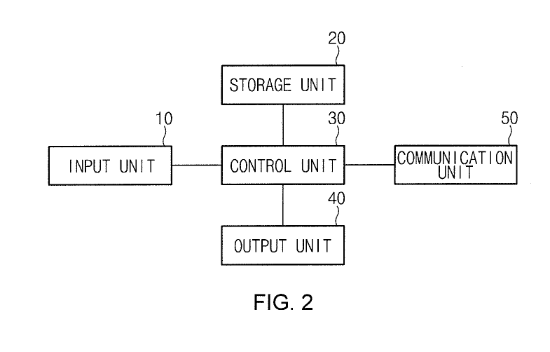

FIG. 2 illustrates the configuration of a speech recognition device configured for a vehicle, according to an exemplary embodiment of the present invention.

As illustrated in FIG. 2, a speech recognition device configured for a vehicle, according to an exemplary embodiment of the present invention, may include an input device 10, a storage device 20, a control device 30, an output device 40, and a communication device 50.

The input device 10 may receive a speech signal of a user. The input device 10 may receive the speech signal with respect to a command uttered by the user. For reference, the input device 10 may convert the speech signal with respect to the command uttered by the user into an electrical audio signal to transmit the converted signal to the control device 30. The input device 10 may perform an operation based on various noise reduction algorithms for eliminating noise generated if receiving external audio signals. The input device 10 may be a microphone.

The storage device 20 may store a wake-up command. The storage device 20 may store a first wake-up command and a second wake-up command.

The first wake-up command may be generated based on some predetermined words or phrases of a command for acquiring a result that may be derived by performing a search based on information stored in a vehicle terminal and a user's personal device. Furthermore, the second wake-up command may be generated based on some predetermined words or phrases of a command for acquiring a result that may be derived by performing a search based on information related to a web server. The first wake-up command and the second wake-up command may be studied and generated by experts and be stored prior to the delivery of the vehicle.

Furthermore, the storage device 20 may store programs for the processing and controlling of the control device 30. The programs stored in the storage device 20 may include an operating system (OS) program and various application programs. Various application programs may include a speech recognition application according to exemplary embodiments of the present invention.

For reference, the programs stored in the storage device 20 may be classified into a plurality of modules according to function. The plurality of modules may include, for example, a mobile communication module, a Wi-Fi module, a Bluetooth module, a DMB module, a camera module, a sensor module, a GPS module, a video playback module, an audio playback module, a power module, a touchscreen module, a UI module, and/or an application module.

The storage device 20 may include a storage medium including a flash memory, a hard disk, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk.

The control device 30 may control the operation of the speech recognition device. To the present end, if the command input by the user is received through the input device 10, the received command may be recognized by distinguishing between a wake-up command and an action command. The control device 30 may recognize the wake-up command from the received command on the basis of the wake-up command prestored in the storage device 20. Furthermore, if the wake-up command is recognized from the received command, it may be determined as one of the first wake-up command and the second wake-up command.

If the first wake-up command is detected from the received speech signal, a terminal speech recognition engine may be driven to perform terminal speech recognition, and if the second wake-up command is detected from the received speech signal, a server speech recognition engine may be driven to perform server speech recognition.

The terminal speech recognition refers to an action of searching for a result corresponding to the user's command on the basis of the information stored in the vehicle terminal and the personal device connected to the vehicle terminal. Furthermore, the server speech recognition refers to an action of searching for a result corresponding to the user's command on the basis of the information related to the web server.

The output device 40 may output a result corresponding to the user's command as either voice or an image. The output device 40 may include a speaker or a display device. The display device may include a liquid crystal display, a thin film transistor-liquid crystal display, an organic light-emitting diode, a flexible display, a 3D display, or an electrophoretic display (EPD). For example, the display device may include a touchscreen, but is not limited to the aforementioned examples.

The communication device 50 may connect the vehicle terminal to the web server in a wired or wireless manner. The communication device 50 may transmit at least one information related to the vehicle terminal to at least one external device or receive the information from at least one external device. The communication device 50 may include one or more components for communications between the vehicle and at least one external device.

For example, the communication device 50 may include at least one of a short-range wireless communicator, a mobile communicator, and a broadcast receiver. The short-range wireless communicator may include a Bluetooth communication module, a Bluetooth low energy (BLE) communication module, a short-range wireless communication module (Near Field Communication device or RFID), a WLAN (Wi-Fi) communication module, a Zigbee communication module, an Ant+communication module, a Wi-Fi Direct (WFD) communication module, a beacon communication module, or an ultra wideband (UWB) communication module, but is not limited thereto. For example, the short-range wireless communicator may include an infrared Data Association (IrDA) communication module.

The mobile communicator may transmit and receive a wireless signal to or from at least one of a base station, an external device, and a server on a mobile communication network. Here, the wireless signal may include various types of data according to the transmission and reception of a voice call signal, a video call signal, or a text/multimedia message. The broadcast receiver may receive a broadcast signal and/or broadcast-related information from the outside through a broadcast channel. The broadcast channel may include at least one of a satellite channel, a terrestrial channel, and a radio channel, but is not limited thereto.

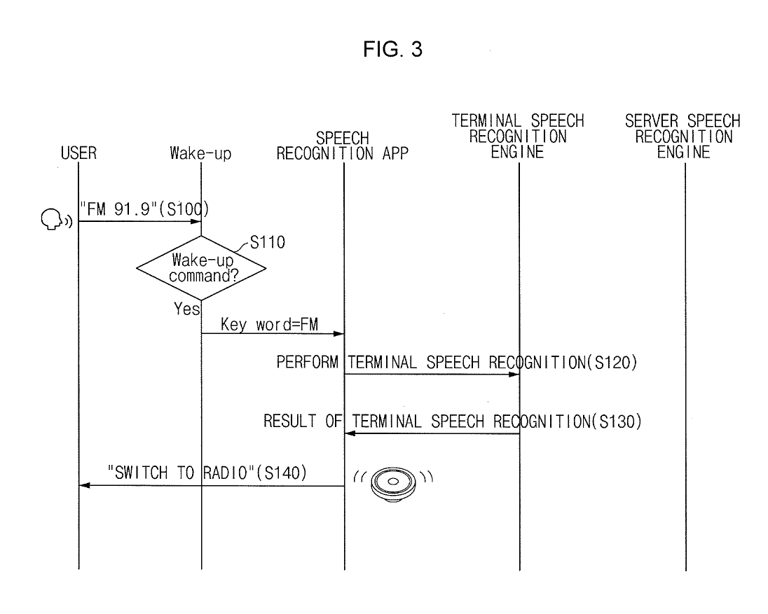

FIG. 3 illustrates a speech recognition method for a vehicle, according to an exemplary embodiment of the present invention.

As illustrated in FIG. 3, a command input by a user may be received in operation S100. In operation S100, the command may include a wake-up command. According to exemplary embodiments of the present invention, a command “FM 91.9” input by the user may be received. Next, it may be determined whether or not the wake-up command is included in the received command in operation S110.

According to exemplary embodiments of the present invention, “FM” in the received command may be detected as the wake-up command. In operation S110, it may be determined that the first wake-up command is detected from the received command. Thus, terminal speech recognition may only be performed to derive a result corresponding to the received command in operation S120. In operation S120, a terminal speech recognition engine may be driven to perform a search based on information stored in a vehicle terminal and a user's personal device.

In other words, instead of performing the terminal speech recognition and server speech recognition simultaneously, operation S120 may include determining whether the first wake-up command or the second wake-up command is detected from the received command, and performing the speech recognition only in a service domain associated with the detected wake-up command, improving a speech recognition rate.

Thereafter, a speech recognition application may receive a result of the terminal speech recognition from the terminal speech recognition engine in operation S130. As such, the result may be output in operation S140. That is, “Switch to radio” may be output in operation S140. In operation S140, the result may be output as either voice or an image.

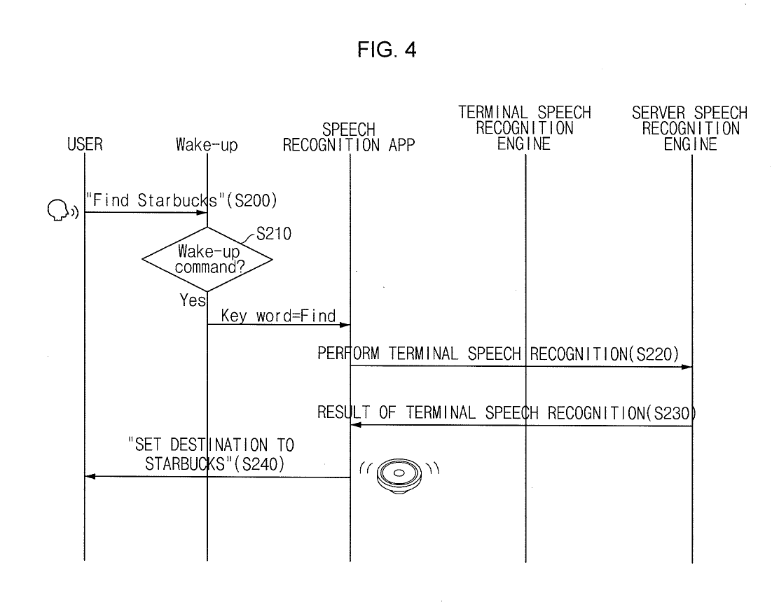

FIG. 4 illustrates a speech recognition method for a vehicle, according to another exemplary embodiment of the present invention.

As illustrated in FIG. 4, a command input by a user may be received in operation S200. In operation S200, the command may include a wake-up command. According to exemplary embodiments of the present invention, a command “Find Starbucks” input by the user may be received. Next, it may be determined whether or not the wake-up command is included in the received command in operation S210.

According to exemplary embodiments of the present invention, “Find” in the received command may be detected as the wake-up command. In operation S210, it may be determined that the second wake-up command is detected from the received command. Thus, server speech recognition may only be performed to derive a result corresponding to the received command in operation S220. In operation S220, a server speech recognition engine may be driven to perform a search based on information related to a web server.

In other words, instead of performing the terminal speech recognition and the server speech recognition simultaneously, operation S220 may include determining whether the first wake-up command or the second wake-up command is detected from the received command, and performing the speech recognition only in a service domain associated with the detected wake-up command, improving a speech recognition rate.

Thereafter, a speech recognition application may receive a result of the server speech recognition from the server speech recognition engine in operation S230. As such, the result may be output in operation S240. That is, “Set destination to Starbucks” may be output in operation S240. In operation S240, the result may be output as either voice or an image.

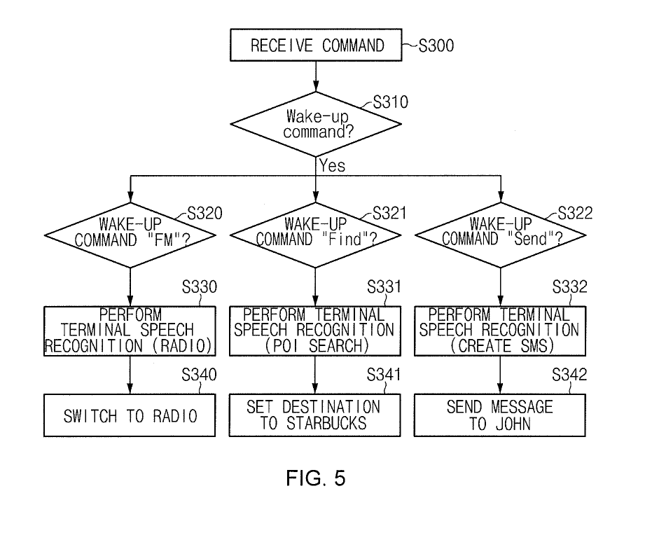

FIG. 5 illustrates a flowchart of a speech recognition method for a vehicle, according to an exemplary embodiment of the present invention.

First of all, a command input by a user may be received in operation S300. Next, it may be determined whether or not a wake-up command is detected from the received command in operation S310. If the wake-up command is detected (Yes), it may be determined whether the wake-up command is a first wake-up command or a second wake-up command in operations S320, S321, and S322. If the wake-up command is not detected (No), a new command uttered by the user may be received.

According to exemplary embodiments, “FM” in the received command may be detected as the wake-up command in operation S320. Since “FM” is determined as the first wake-up command, terminal speech recognition with respect to the received command may be performed in operation S330. The speech recognition with respect to the received command may be performed in a service domain of “radio” in operation S330. A speech recognition result may be “Switch to radio”, which may be output as either voice or an image in operation S340.

According to exemplary embodiments, “Find” in the received command may be detected as the wake-up command in operation S321. Since “Find” is determined as the second wake-up command, server speech recognition with respect to the received command may be performed in operation S331. The speech recognition with respect to the received command may be performed in a service domain of “POI search” in operation S331. A speech recognition result may be “Set destination to Starbucks”, which may be output as either voice or an image in operation S341.

According to exemplary embodiments, “Send” in the received command may be detected as the wake-up command in operation S322. Since “Send” is determined as the second wake-up command, server speech recognition with respect to the received command may be performed in operation S332. The speech recognition with respect to the received command may be performed in a service domain of “Create SMS” in operation S332. A speech recognition result may be “Send message to John”, which may be output as either voice or an image in operation S342.

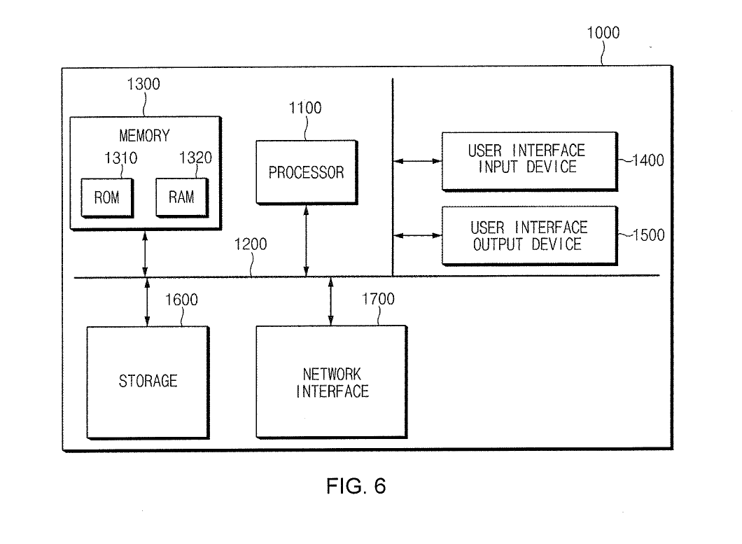

FIG. 6 illustrates the configuration of a computing system by which a method according to an exemplary embodiment of the present invention is executed.

Referring to FIG. 6, a computing system 1000 may include at least one processor 1100, a bus 1200, a memory 1300, a user interface input device 1400, a user interface output device 1500, a storage 1600, and a network interface 1700, wherein these elements are connected through the bus 1200.

The processor 1100 may be a central processing unit (CPU) or a semiconductor device processing commands stored in the memory 1300 and/or the storage 1600. The memory 1300 and the storage 1600 include various types of volatile or non-volatile storage media. For example, the memory 1300 may include a read only memory (ROM) and a random access memory (RAM).

Therefore, the steps of the method or algorithm described with reference to the exemplary embodiments disclosed herein may be embodied directly in hardware, in a software module executed by the processor 1100, or in a combination thereof. The software module may reside in a storage medium (i.e., the memory 1300 and/or the storage 1600) including RAM, a flash memory, ROM, an erasable programmable read-only memory (EPROM), an electrically erasable programmable read-only memory (EEPROM), a register, a hard disk, a removable disk, and a CD-ROM. An exemplary storage medium may be coupled to the processor 1100, such that the processor 1100 may read information from the storage medium and write information to the storage medium. Alternatively, the storage medium may be integrated with the processor 1100. The processor 1100 and the storage medium may reside in an application specific integrated circuit (ASIC). The ASIC may reside in a user terminal. Alternatively, the processor 1100 and the storage medium may reside as discrete components in a user terminal.

As set forth above, in a hybrid speech recognition system according to exemplary embodiments, if a command including a wake-up command classified and registered according to a service domain is input, the system may receive the command, detect the wake-up command, and limit the service domain which is to be activated according to the received command, increasing a speech recognition rate.

Furthermore, by determining a specific service domain to which the received command belongs, unnecessary consumption of data to search for a result with respect to the received command may be prevented.

Furthermore, the speech recognition may be activated even if a command including the wake-up command which is presented in the exemplary embodiments is input instead of the user's input of the wake-up command for activating the speech recognition. Thus, the speech recognition may be activated easily and rapidly.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A speech recognition device for a vehicle, comprising:
an input device receiving a command;
a storage device storing a first wake-up command generated to perform terminal speech recognition with respect to the received command, and a second wake-up command generated to perform server speech recognition with respect to the received command;
a controller configured for determining whether at least one of the first wake-up command and the second wake-up command is detected from the received command, performing the terminal speech recognition if the first wake-up command is detected from the received command, and performing the server speech recognition if the second wake-up command is detected from the received command; and
an output device outputting at least one of a result of the terminal speech recognition and a result of the server speech recognition.

2. The speech recognition device according to claim 1, wherein the input device receives the command including at least one of the first wake-up command and the second wake-up command.

3. The speech recognition device according to claim 1, wherein the storage device stores the first wake-up command generated based on at least one of a predetermined word and a predetermined phrase of a command for acquiring a result which is derived by performing a search based on information stored in a vehicle terminal and a user's personal device connected to the vehicle terminal.

4. The speech recognition device according to claim 1, wherein the storage device stores the second wake-up command generated based on at least one of a predetermined word and a predetermined phrase of a command for acquiring a result which is derived by performing a search based on information related to a web server.

5. The speech recognition device according to claim 1, wherein the controller is configured to recognize the received command by distinguishing between a wake-up command and an action command on a basis of the first wake-up command and the second wake-up command stored in the storage device, and detects the wake-up command as at least one of the first wake-up command and the second wake-up command.

6. The speech recognition device according to claim 1, wherein the controller is configured to perform the terminal speech recognition through an action of searching for a result corresponding to a user's command on a basis of information stored in a vehicle terminal and a personal device connected to the vehicle terminal.

7. The speech recognition device according to claim 1, wherein the controller is configured to perform the server speech recognition through an action of searching for a result corresponding to a user's command on a basis of information related to a web server.

8. The speech recognition device according to claim 1, wherein the controller is configured to perform the terminal speech recognition by allowing the speech recognition of the received command to be performed in a service domain based on a vehicle terminal and a personal device connected to the vehicle terminal.

9. The speech recognition device according to claim 1, wherein the controller is configured to perform the server speech recognition by allowing the speech recognition of the received command to be performed in a service domain based on a web server.

10. A speech recognition method for a vehicle, comprising:
receiving a command;
detecting at least one of a first wake-up command and a second wake-up command from the received command;
performing terminal speech recognition if the first wake-up command is detected from the received command, and performing server speech recognition if the second wake-up command is detected from the received command; and
outputting at least one of a result of the terminal speech recognition and a result of the server speech recognition.

11. The speech recognition method according to claim 10, further including storing the first wake-up command generated based on at least one of a predetermined word and a predetermined phrase of a command for acquiring a result which is derived by performing a search based on information stored in a vehicle terminal and a user's personal device connected to the vehicle terminal, before the receiving of the command.

12. The speech recognition method according to claim 10, further including storing the second wake-up command generated based on at least one of a predetermined word and a predetermined phrase of a command for acquiring a result which is derived by performing a search based on information related to a web server, before the receiving of the command.

13. The speech recognition method according to claim 10, wherein the receiving of the command includes receiving the command including at least one of the first wake-up command and the second wake-up command.

14. The speech recognition method according to claim 11, wherein the detecting of at least one of a first wake-up command and a second wake-up command from the received command includes:
recognizing the received command by distinguishing between a wake-up command and an action command on a basis of the stored first wake-up command and the stored second wake-up command; and
detecting the wake-up command as at least one of the first wake-up command and the second wake-up command.

15. The speech recognition method according to claim 10, wherein the performing of the terminal speech recognition if the first wake-up command is detected from the received command, and the performing of the server speech recognition if the second wake-up command is detected from the received command includes:
performing the terminal speech recognition through an action of searching for a result corresponding to a user's command on a basis of information stored in a vehicle terminal and a personal device connected to the vehicle terminal; and
performing the server speech recognition through an action of searching for a result corresponding to the user's command on a basis of information related to a web server.

16. The speech recognition method according to claim 10, wherein the performing of the terminal speech recognition if the first wake-up command is detected from the received command includes performing the terminal speech recognition by allowing the speech recognition of the received command to be performed in a service domain based on a vehicle terminal and a personal device connected to the vehicle terminal.

17. The speech recognition method according to claim 10, wherein the performing of the server speech recognition if the second wake-up command is detected from the received command includes performing the server speech recognition by allowing the speech recognition of the received command to be performed in a service domain based on a web server.
